(19) United States
(12) Patent Application Publication
(10) Pub. No.: US 2002/0170789 A1
(43) Pub. Date: Nov. 21, 2002

(54) Backing plate with friction material retention members and method and apparatus for manufacturing same

(76) Inventor: Doug Poelemans, Aurora (CA)

Correspondence Address: Robin L.A. Coster, Bereskin & Parr, Box 401, 40 King Street West, Toronto, ON, M5H 3Y2, CA

(21) Appl. No.: 09/858,883

(22) Filed: May 17, 2001

(51) Int. Cl. F16D 69/00

(52) U.S. Cl. 188/250 R; 188/68

(57) ABSTRACT

The invention provides a backing plate for a friction assembly. The backing plate includes a body having a first surface and a second surface. At least one retention member is defined in the first surface. The retention member has a depressed portion defined beneath the first surface and a protruding portion extending in a spiral orientation above the first surface. A method and apparatus for manufacturing the backing plate is also provided.

### FIELD OF THE INVENTION

The present invention relates to braking assemblies and in particular to brake backing plates.

### BACKGROUND OF THE INVENTION

A conventional brake assembly includes a friction assembly for frictionally engaging a moving member such as a brake rotor. The friction assembly comprises a friction material that is secured to a backing plate. The friction assembly is supported in the brake assembly for selective engagement with the item to be braked. Due to the stresses exerted upon the friction assembly during braking, it is important that the backing plate is resistant to bending or breaking and that the engagement between the friction material and the backing plate is secure.

Typically, backing plates are modified to include bores, cavities, gouges or protuberances to receive and engage the friction material. In some instances, these modifications impinge upon the structural integrity of the backing plate and in other instances the modifications do not provide a sufficiently secure engagement between the backing plate and the friction material. Also, the costs associated with manufacturing backing plates with such modifications can often be prohibitive.

There is a need for an improved backing plate and an improved method and apparatus for producing a backing plate that overcomes the above described problems.

### SUMMARY OF THE INVENTION

The present invention provides a backing plate with a plurality of retention members for engaging a friction material. Each retention member includes a depressed portion and at least one protruding portion that extends in a spiral orientation. The invention also provides a method and apparatus for manufacturing the backing plate.

In one aspect the invention provides a backing plate for a friction assembly comprising:

a) a body having a first surface and a second surface; and

b) at least one retention member defined in said first surface, said retention member having a depressed portion defined beneath said first surface and a protruding portion extending in a spiral orientation above said first surface.

In another aspect the invention provides a friction assembly for a brake assembly comprising:

a) a backing plate having a body having a first surface and a second surface;

b) at least one retention member defined in said first surface, said retention member having a depressed portion defined beneath said first surface and a protruding portion extending in a spiral orientation above said first surface; and

c) a friction material molded to said first surface of said backing plate so that said friction material is engaged by said at least one retention member.

In another aspect the invention provides a method for manufacturing a backing plate with retention members comprising:

a) pressing cutting tool against a first surface of a backing plate blank; and

b) moving at least one of said cutting tool and said backing plate blank relative to the other under pressure to form a retention member in said backing plate blank, said retention member having a protruding portion extending in a spiral orientation above said first surface.

In another aspect the invention provides an apparatus for manufacturing a backing plate with retention members comprising:

a) means for pressing a cutting tool against a first surface of said backing plate blank; and

b) means for moving at least one of said cutting tool and said backing plate blank under pressure relative to the other to form a retention member in said backing plate blank, said retention member having a protruding portion extending in a spiral orientation above said first surface.

### BRIEF DESCRIPTION OF THE DRAWINGS

For a better understanding of the present invention, and to show more clearly how it may be carried into effect, reference will now be made by way of example to the accompanying drawings. The drawings show preferred embodiments of the present invention, in which:

FIG. 1 is a perspective view of a friction assembly in accordance with the present invention;

FIG. 2 is a perspective view of a backing plate for the friction assembly of FIG. 1;

FIG. 3 is a sectional view of the backing plate of FIG. 1 taken along lines 3-3;

FIG. 4 is an enlarged perspective view of a retention member for the backing plate of FIG. 2;

FIG. 5 is a side view of an apparatus for forming one or more retention members in backing plate blanks in accordance with the present invention;

FIG. 6 is a top perspective view of a lower die shoe for the apparatus of FIG. 5;

FIG. 7 is a bottom perspective view of an upper die shoe for the apparatus of FIG. 5;

FIG. 8 is an exploded view of a tool assembly for the apparatus of FIG. 5.

FIG. 9 is a sectional view of the tool assembly of FIG. 8 taken along lines 9-9;

FIG. 10 is a side view of a cutting tool for the tool assembly of FIG. 8;

FIG. 11 is an enlarged side view of the end of the cutting tool of FIG. 10; and

FIGS. 12(a)-12(d) are plan views of backing plate blanks with retention members formed at successive work stations in the apparatus of FIG. 5;

### DETAILED DESCRIPTION OF THE INVENTION

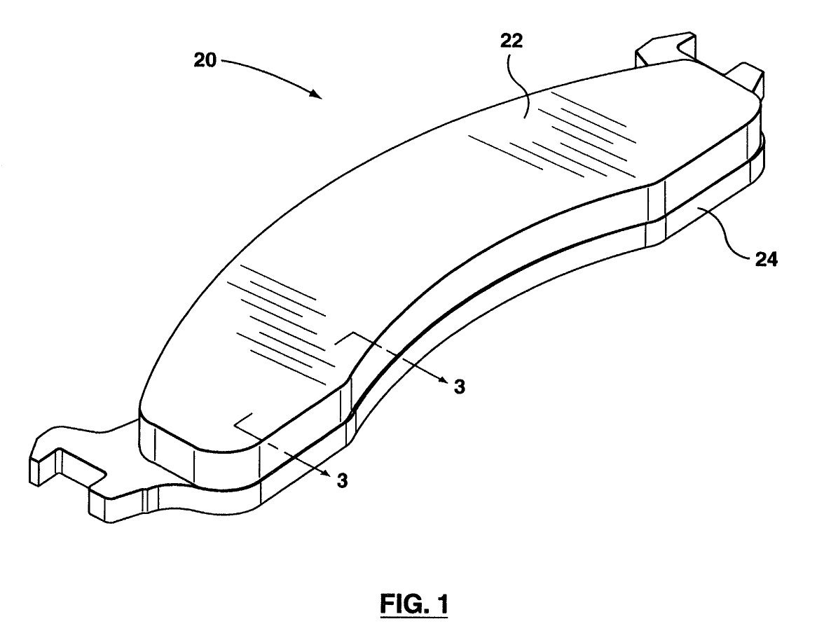

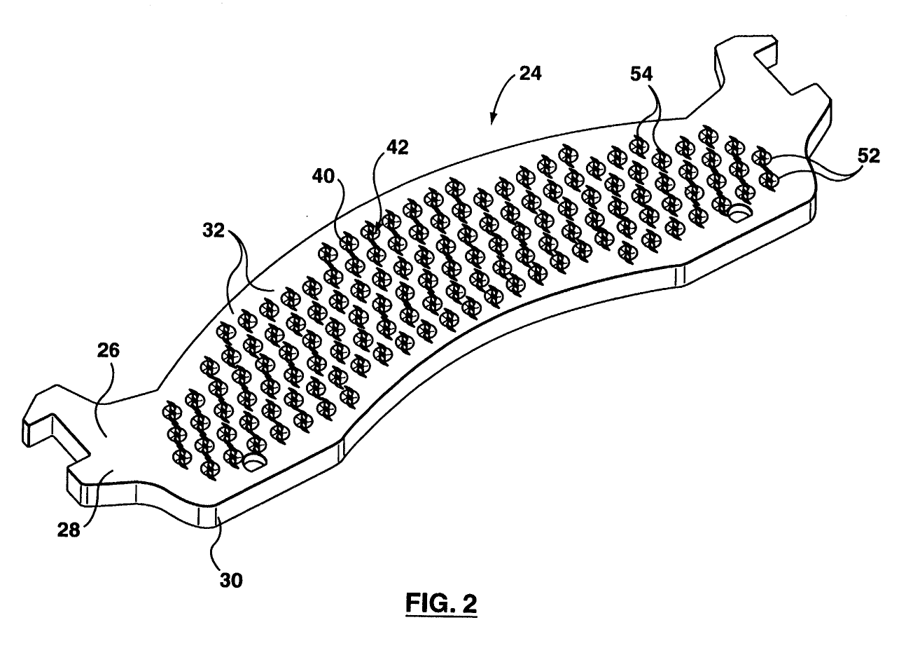

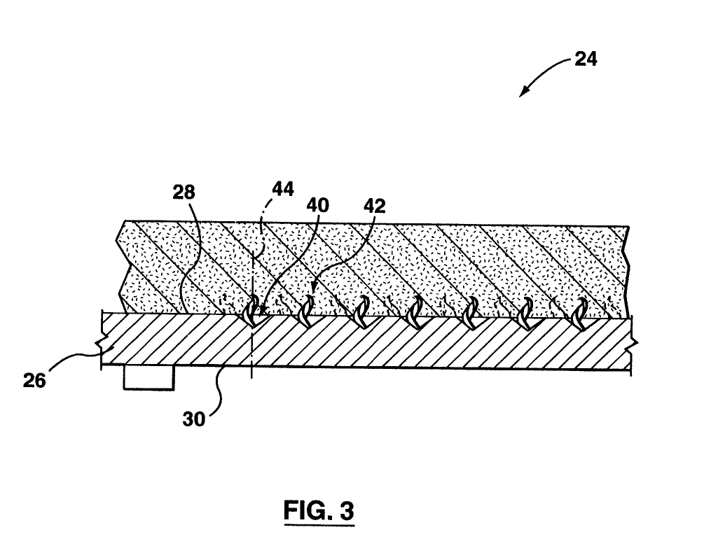

A friction assembly in accordance with the present invention is shown generally at 20 in FIG. 1. Friction assembly 20 includes a friction material 22 that is molded in known manner to a backing plate 24.

Backing plate 24 is formed of metal, a metal composite or such other material that is suitable for the intended use of the present invention and that may be processed in accordance with the method described below. Backing plate 24 is of a conventional shape and thickness and may include apertures and other structural elements known in the art to permit backing plate to be incorporated within a brake assembly (not shown).

Backing plate 24 has a body 26 with a planar first surface 28 and an opposing planar second surface 30. First surface 28 defines a plurality of retention members 32 for engaging friction material 22 once it has been disposed on first surface 28.

Retention members 32 comprise a depressed portion 40 defined beneath first surface 28 of backing plate 24 and a pair of protruding portions 42 extending from depressed portion 40 to a point above first surface 28. Protruding portions 42 are integrally formed with backing plate 24 from material displaced during formation of depressed portion 40. Protruding portions 42 extend in a spiral orientation in a clockwise or counterclockwise direction about a central axis 44 of depressed portion 40 (the embodiment depicted in the Figures extends in a clockwise direction). Protruding portions 42 each have a body 46 with a tip 48 and a base 50. To further improve the engagement between retention members 32 and friction material 22, body 46 of each protruding portion 42 preferably has an engaging face 51 that extends in a spiral orientation from base 50 to tip 48. Engaging face 51 defines a mechanical deformation along the length of body 46 that improves the engagement with friction material 22. Protruding portions 42 preferably have a height of between 0.030-0.075 inches above first surface 28.

Retention members 32 are arranged on first surface 28 of backing plate 24 in a density and pattern that provides optimal retention of friction material 22 while maintaining optimal structural integrity of backing plate 28. Preferably, retention members 32 are arranged in rows 52 and columns 54 on first surface 28 with retention members 32 in adjacent rows 52 being arranged in offset columns 54. In a preferred embodiment, at least ten retention members 32 are arranged on backing plate 28 per square inch to provide coverage of 65% or more of the area of first surface 28. This embodiment is preferred for use in brake assemblies for disc brakes. It will be appreciated by those skilled in the art that the density, pattern and size of retention members 32 may be modified in accordance with the intended braking application without departing from the spirit of the invention.

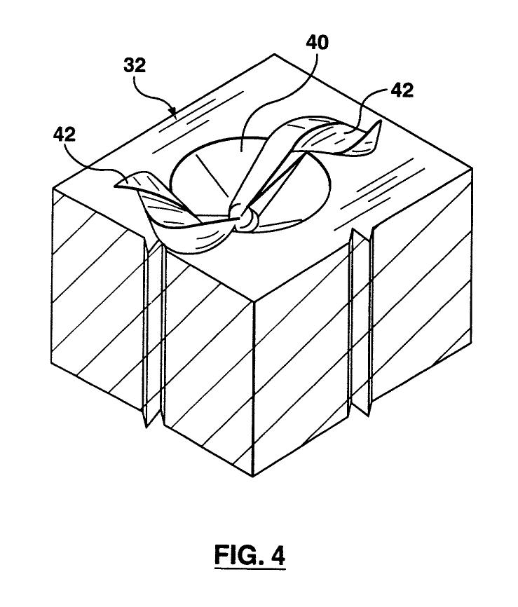

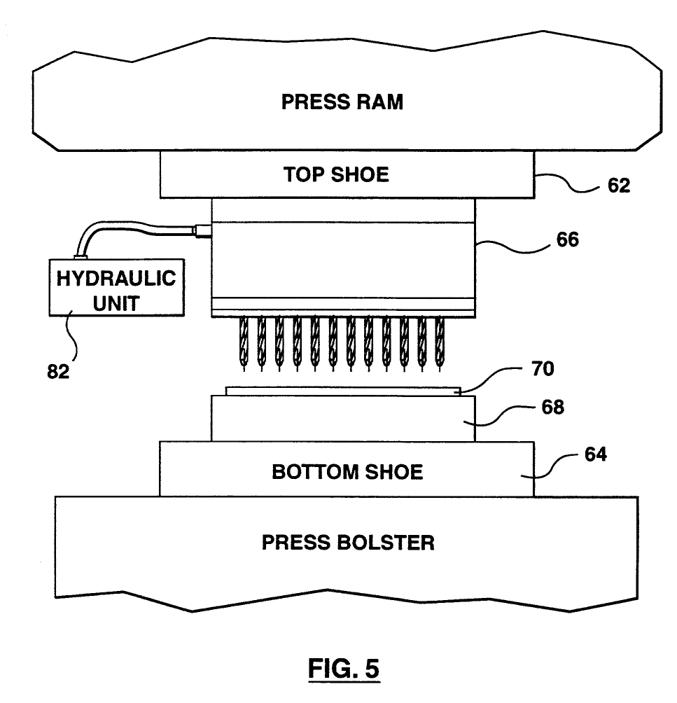

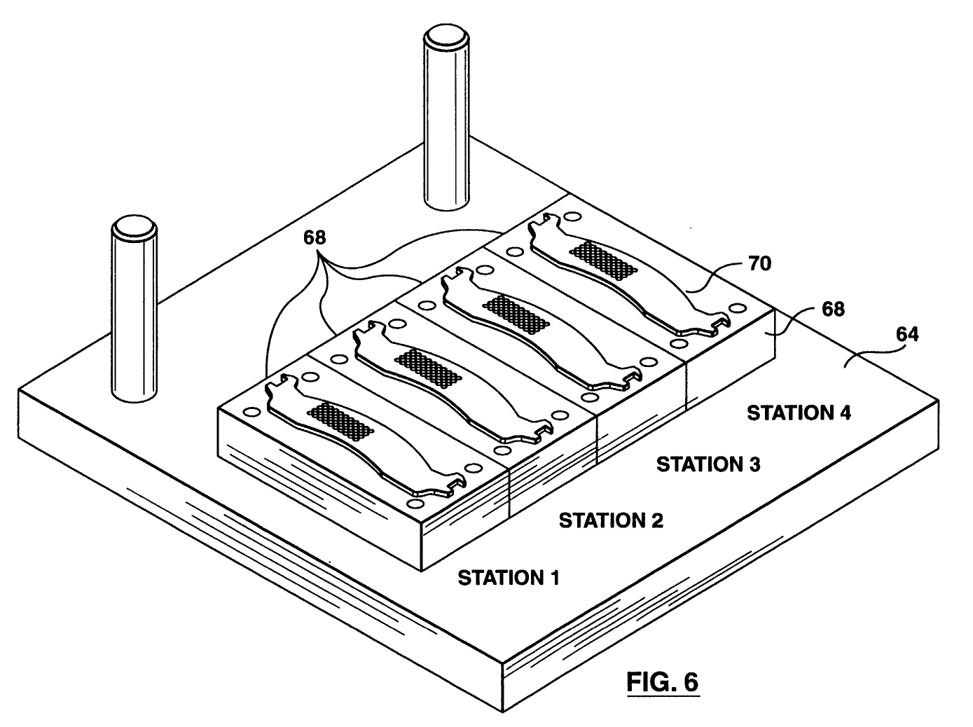

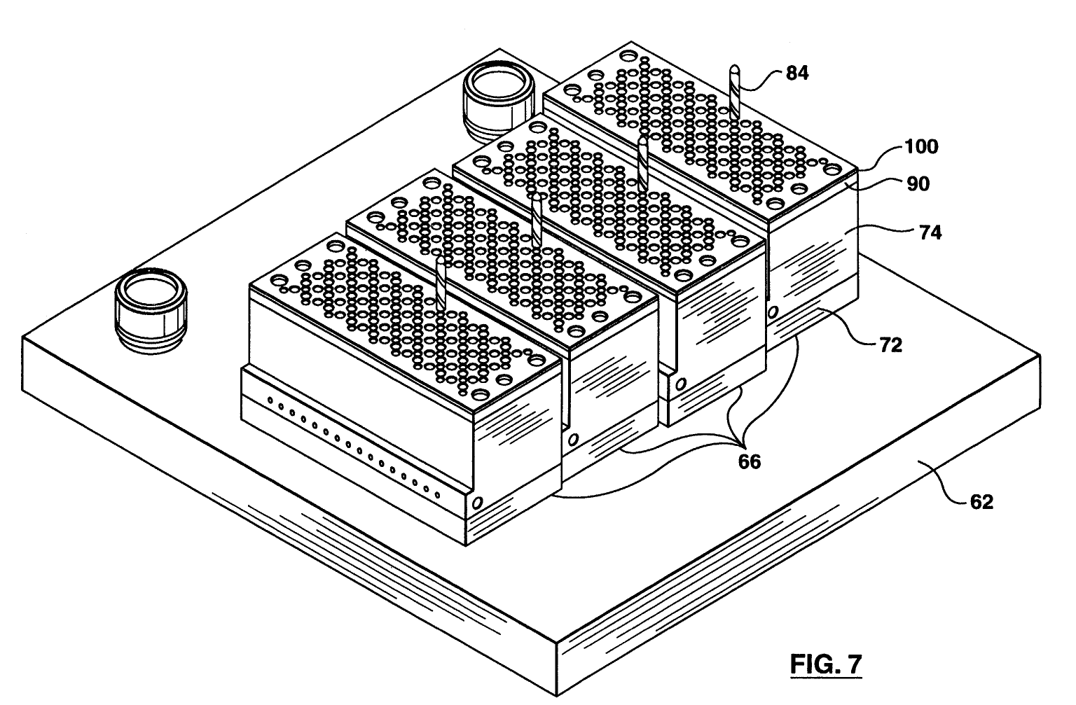

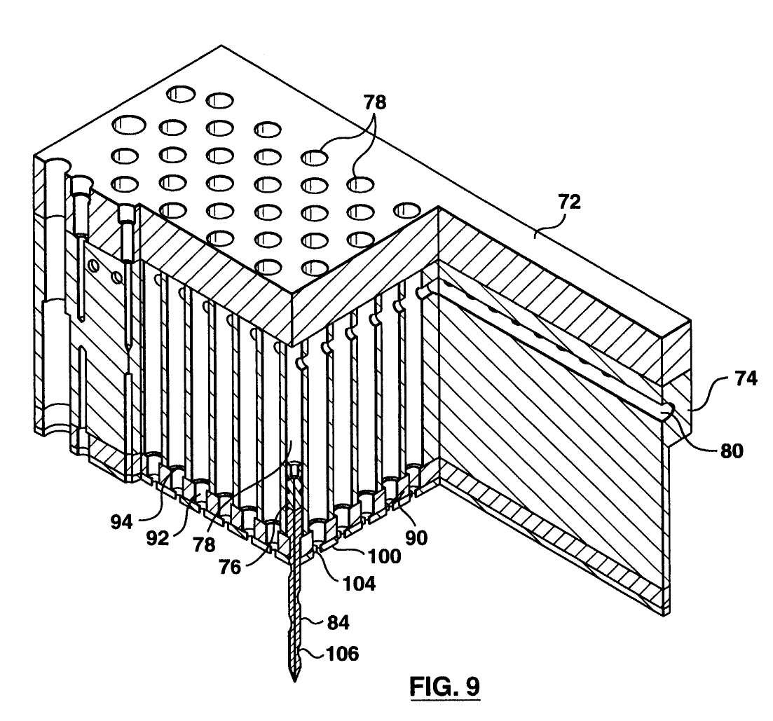

Backing plate 24 is preferably manufactured in a press apparatus 60 having an upper die shoe 62 and a lower die shoe 64 as shown in FIGS. 5 to 11. Upper die shoe 62 supports one or more tool assemblies 66 and lower die shoe 64 supports a corresponding one or more workstations 68 for supporting backing plate blanks 70 during the manufacturing process.

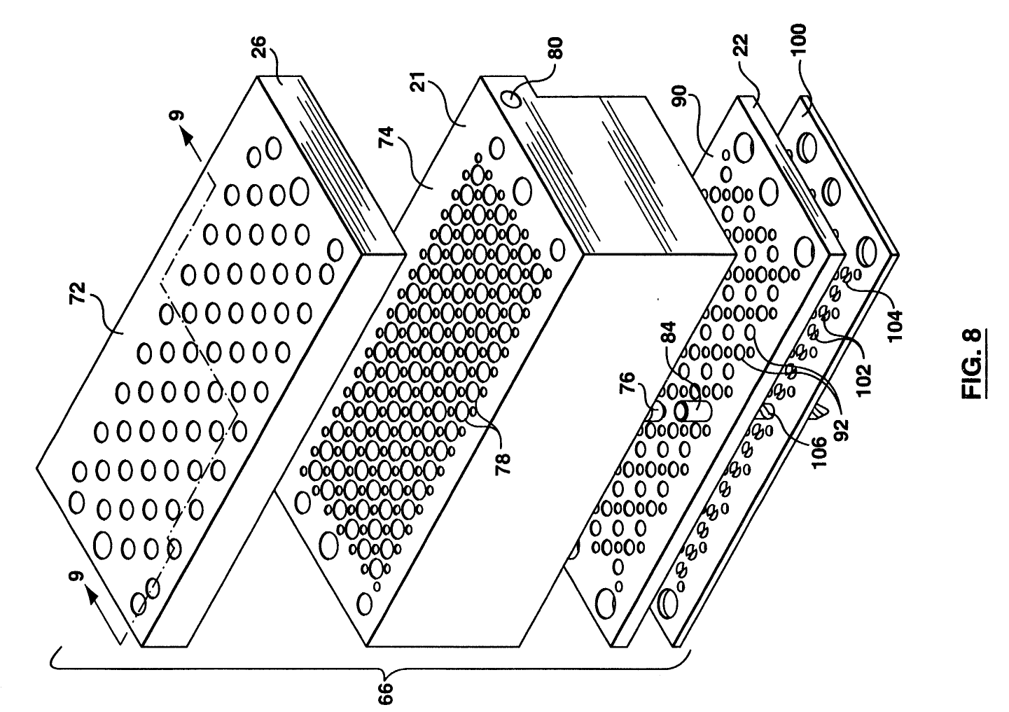

Referring to FIGS. 8-11, the structure of tool assembly 66 may be seen more clearly. Tool assembly 66 includes base plate 72 that is mounted to upper die shoe 62. A cylinder block 74 is mounted beneath base plate 72. A plurality of pistons 76 are slidably disposed in bores 78 defined in cylinder block 74. A manifold 80 is defined in cylinder block 74 for transferring hydraulic pressure to pistons 76 from a hydraulic pump 82. Pistons 76 are abuttably connected to cutting tools 84 that are slidably and rotatably disposed in bores 78 and protrude from cylinder block 74.

Stop plate 90 is mounted beneath cylinder block 74. Stop plate 90 defines a plurality of bores 92 that are aligned with bores 78 of cylinder block 74 to slidably and rotatably receive cutting tools 84 extending from cylinder block 74. Stop plate bores 92 have a narrower diameter than cylinder block bores 78 to define a shoulder 94 for engaging step 96 defined on cutting tool 84.

Twisting plate 100 is mounted beneath stop plate 90. Twisting plate 100 defines a plurality of bores 102 that are aligned with bores 92 of stop plate 90 to slidably and rotatably receive cutting tools 84 extending from stop plate 90. Twisting plate bores 102 are configured with guides 104 that are seated within grooves 106 of cutting tools 84 to impart rotatable motion to cutting tools 84 as they move slidably in bores 102 as described more fully below.

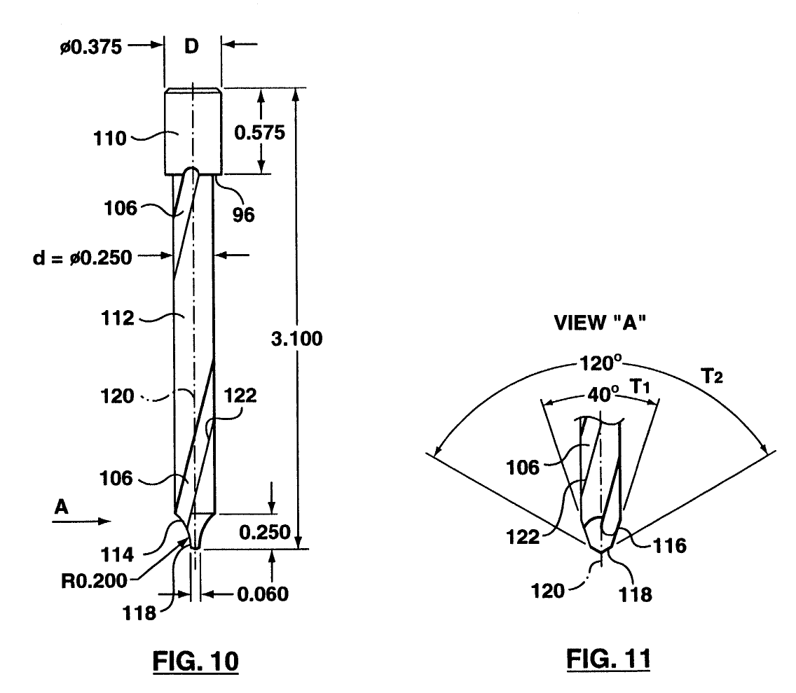

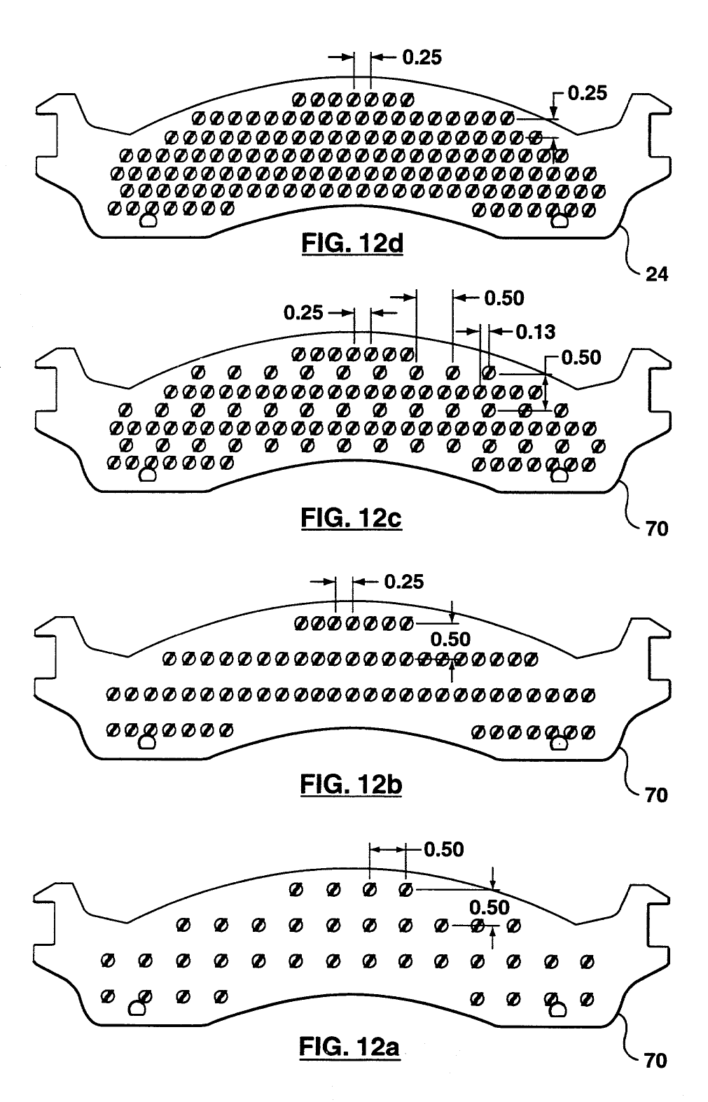

Referring to FIGS. 10 and 11, cutting tool 84 is shown in greater detail. Cutting tool 84 has a head 110, a shaft 112 and a tip 114. Head 110 has a diameter D that is greater than diameter d of shaft 112. Step 96 is defined at the junction of head 110 and shaft 112 for abutting shoulder 94 on stop plate 90 as described above. Tip 114 has a first tapered portion 116 and a second tapered portion 118. First tapered portion 116 preferably tapers at a more acute angle to a central axis 120 of cutting tool compared to second tapered portion 118. It has been found that a taper angle T1 of 20° is preferred for first tapered portion 116 and a tapered angle T2 of 60° is preferred for second tapered portion 118. Cutting tool 84 defines a pair of grooves 106 that extend in a spiral along tip 114 and shaft 112. Grooves 106 include cutting edges 122 that are adapted for cutting depressed portions 40 and protruding portions 42 in first surface 28 of backing plate blanks 70.

The preferred method of forming retention members 32 and backing plates 24 is as follows. Backing plate blanks 70 are disposed on workstations 68 of lower die shoe 64. Preferably backing plate blanks 70 will be moved into position on workstations 68 by a mechanical device (not shown) that is timed in conjunction with the stroke of press 60.

During the downstroke of press 60, tips 114 of cutting tools 84 protruding from tool assemblies 66 in upper die shoe 62 are moved to a position where they come into contact with first surface 28 of backing plate blanks 70. As the downstroke of press 60 continues, the contact between cutting tools 84 and backing plate blanks 70 forces cutting tools 84 to recede within cylinder block 74. As cutting tools 84 are receding within cylinder block 74, guides 104 defined in twisting plate 100 cause cutting tools 84 to rotate on their respective axes 120. In view of the counter force placed upon pistons 76 by hydraulic pressure from pump 82, cutting tools 84 cut into backing plate blanks 70 to form retention members 32.

At the end of the downstroke of press 60, hydraulic pressure to cylinder 74 block is cut off or sufficiently reduced to allow cutting tools 84 to remain in their final position during the upstroke of press 60. This prevents the cutting tools 84 from reversing on their axes 120 during the upstroke of press 60.

At the end of the upstroke of press 60, hydraulic pressure is once again introduced to cylinder block 74 and pistons 76 thus act to push cutting tools 84 down to a starting position for the next cycle. During each successive cycle backing plate blanks 70 are moved to successive workstations 68 either manually or with the assistance of a mechanical device (not shown) timed with the stroke of press 60.

It is to be understood that what has been described is a preferred embodiment to the invention. If the invention nonetheless is susceptible to certain changes and alternative embodiments fully comprehended by the spirit of the invention as described above, and the scope of the claims set out below.

1. A backing plate for a friction assembly comprising:
a) a body having a first surface and a second surface; and
b) at least one retention member defined in said first surface, said retention member having a depressed portion defined beneath said first surface and a protruding portion extending in a spiral orientation above said first surface.

2. A backing plate as claimed in claim 1 wherein said depressed portion has a central axis and said protruding portion extends in said spiral orientation about said central axis.

3. A backing plate as claimed in claim 1 wherein said protruding portion extends in said spiral orientation for less than one full revolution.

4. A backing plate as claimed in claim 1 wherein said retention member has a plurality of said protruding portions.

5. A backing plate as claimed in claim 4 wherein said spiral orientation of each of said protruding portions extends in the same direction.

6. A backing plate as claimed in claim 5 wherein said direction of spiral orientation for said protruding portions is a clockwise direction.

7. A backing plate as claimed in claim 1, wherein said protruding portion has a mechanical deformation defined along its length.

8. A backing plate as claimed in claim 7 wherein said mechanical deformation is an engaging face extending in a spiral orientation along the length of said body.

9. A friction assembly for a brake assembly comprising:
a) a backing plate having a body having a first surface and a second surface;
b) at least one retention member defined in said first surface, said retention member having a depressed portion defined beneath said first surface and a protruding portion extending in a spiral orientation above said first surface; and
c) a friction material molded to said first surface of said backing plate so that said friction material is engaged by said at least one retention member.

10. A friction assembly as claimed in claim 9 wherein said depressed portion has a central axis and said protruding portion extends in said spiral orientation about said central axis.

11. A friction assembly as claimed in claim 9 wherein said protruding portion extends in said spiral orientation for less than one full revolution.

12. A friction assembly as claimed in claim 9 wherein said retention member has a plurality of said protruding portions.

13. A friction assembly as claimed in claim 12 wherein said spiral orientation of each of said protruding portions extends in the same direction.

14. A friction assembly as claimed in claim 13 wherein said direction of spiral orientation for each of said protruding portions is a clockwise direction.

15. A backing plate as claimed in claim 9, wherein said protruding portion has a mechanical deformation defined along its length.

16. A backing plate as claimed in claim 15 wherein said mechanical deformation is an engaging face extending in a spiral orientation along the length of said body.

17. A method for manufacturing a backing plate with retention members comprising:
a) pressing cutting tool against a first surface of a backing plate blank; and
b) moving at least one of said cutting tool and said backing plate blank relative to the other under pressure to form a retention member in said backing plate blank, said retention member having a protruding portion extending in a spiral orientation above said first surface.

18. A method as claimed in claim 17 wherein, in said moving step, said cutting tool is moved relative to said backing plate blank.

19. A method as claimed in claim 17 wherein said cutting tool has an elongate shaft defining at least one groove with a cutting edge.

20. A method as claimed in claim 17 wherein said cutting tool is supported in a tool assembly having at least one guide for traveling in a corresponding at least one groove defined in said cutting tool for imparting movement to said cutting tool relative to said backing plate blank.

21. An apparatus for forming a backing plate with retention members comprising:
a) means for pressing a cuffing tool against a first surface of said backing plate blank; and
b) means for moving at least one of said cutting tool and said backing plate blank under pressure relative to the other to form a retention member in said backing plate blank, said retention member having a protruding portion extending in a spiral orientation above said first surface.

22. An apparatus as claimed in claim 21 wherein said pressing means comprises a press apparatus having a first die shoe for supporting said cutting tool, a second die shoe for supporting said backing plate blank and an actuator for moving at least one of said first die shoe and said second die shoe towards and away from the other.

23. An apparatus as claimed in claim 22 wherein said moving means comprises a tool assembly for supporting said cutting tool, said tool assembly having at least one guide that travels in a corresponding at least one groove defined in said cutting tool for imparting movement to said cutting tool relative to said backing plate blank when said actuator moves said first die shoe and said second die shoe towards and away from the other.
